(19) United States
(12) Patent Application Publication
(10) Pub. No.: US 2018/0302718 A1
(43) Pub. Date: Oct. 18, 2018

(54) AUDIO OUTPUT APPARATUS AND HEADSET COMPRISING SUCH APPARATUS

(71) Applicant: Tools Design I/S, Copenhagen NV (DK)

(72) Inventors: Claus JENSEN, Copenhagen NV (DK); Henrik Peter HOLBÆK, Copenhagen NV (DK)

(21) Appl. No.: 15/938,212

(22) Filed: Mar. 28, 2018

(30) Foreign Application Priority Data
Apr. 17, 2017 (DK) PA 2017 00253

(51) Int. Cl. H04R 5/033; H04R 1/10

(52) U.S. Cl. CPC H04R 5/0335; H04R 1/1066; H04R 1/1008

(57) ABSTRACT

An audio output apparatus (1) adapted for being releasably attached to an auricle (2) of a user. The apparatus includes a first attachment member (3) and a second attachment member (4), the first attachment member (3) and the second attachment member (4) being magnetically attracted to each other. A housing (5) includes an audio output component (8) and the first attachment member (3). A flexible elongated member (6) extends from the housing (5), the second attachment member (4) is secured to the flexible elongated member (6) at an adjustable position along the flexible elongated member (6) to allow for manual adjustment of a distance (d) along the flexible elongated member (6) between the housing (5) and the second attachment member (4). The second attachment member (4) is adapted for engaging magnetically with the first attachment member (3) through the auricle (2) of the user with the distance (d) matching the size of the auricle (2) of the user.

### TECHNICAL FIELD

The disclosure relates to an audio output apparatus adapted for being releasably attached to an auricle of a user, and to a headset comprising such an audio output apparatus.

### BACKGROUND

A common type of headset is the earphone, i.e. a headset which comprises two earbuds connected by a forked cable which extends freely from the earbuds. One disadvantage with such a solution is that the cable frequently entangles when the headset is not in use. Another disadvantage is that the cable might get caught in something during use, unintentionally pulling the earbuds from the ears of the user.

Another type of headset is a wireless headset which is attached more firmly to the auricle (outer ear) of the user. Such a solution is shown in US2016381448, which describes an earphone attached to an auricle by means of a hook member which is curved to fit the shape of an auricle. Both the earbud and the hook member are provided with magnets, which attract one another and hence prevents the earphone from being dislodged from the auricle.

Such a solution provides no flexibility as regards the placement of the opposing magnets, hence the device cannot be adapted to the shape or size of an individual ear. Further, a more or less pre-shaped hook member reduced the degree of possible individual adaptation.

Hence, there is a need for providing a more flexible type of headset, which is individually adaptable to the user's ear yet still is securely attached to the user's ear during e.g. physical activity. Further, it is desirable to provide a headset which does not entangle.

### SUMMARY

It is an object of the aspects of the disclosed embodiments to solve or at least reduce the problems indicated above.

This object is achieved according to a first aspect by an audio output apparatus adapted for being releasably attached to an auricle of a user, the apparatus comprising a first attachment member and a second attachment member, the first attachment member and the second attachment member being magnetically attracted to each other, a housing comprising an audio output component and the first attachment member, a flexible elongated member extending from the housing, the second attachment member being secured to the flexible elongated member at an adjustable position along the flexible elongated member to allow for manual adjustment of a distance along the flexible elongated member between the housing and the second attachment member, the second attachment member being adapted for engaging magnetically with the first attachment member through the auricle of the user with the distance matching the size of the auricle of the user.

An audio output apparatus which comprises two separate attachment members, which are magnetically attracted to each other through the auricle of the user, and which is adjustable in relation to each other, is properly secured to the ear of the user even during physical activity such as sports. The apparatus is especially suitable for use in connection with Bluetooth earphones that do not extend into the ear canal. Also, the apparatus is highly flexible in that it may be adjusted to fit a wide range of differently shaped ears comfortably. Further, the apparatus is easy to use and does not take up much space, neither in use nor when not in use.

In a first possible implementation form of the first aspect, one of the first attachment member and the second attachment member comprises a permanent magnet, and one of the second attachment member and the first attachment member comprises a magnetic material.

In a second possible implementation form of the first aspect, the first attachment member and the second attachment member both comprise a permanent magnet.

In a third possible implementation form of the first aspect, the first attachment member comprises a permanent magnet and the second attachment member is a wire of magnetic material arranged within the flexible elongated member.

In a fourth possible implementation form of the first aspect, the second attachment member comprises a channel through which the flexible elongated member extends, the second attachment member being maintained on the flexible elongated member by means of friction.

In a fifth possible implementation form of the first aspect, the second attachment member comprises a threaded channel through which a correspondingly threaded section of the flexible elongated member extends.

In a sixth possible implementation form of the first aspect, the housing is shaped to at least partially be received in a cavum of concha of the auricle.

In a seventh possible implementation form of the first aspect, the housing is an earbud.

In a eight possible implementation form of the first aspect, the flexible elongated member is a cord, a wire, or a cable.

This object is also achieved according to a second aspect by an audio output apparatus adapted for being releasably attached to an auricle of a user, the apparatus comprising a first attachment member and a second attachment member, the first attachment member and the second attachment member being magnetically attracted to each other, a housing comprising an audio output component and the first attachment member, a flexible elongated member extending from the housing, the second attachment member comprising an array of magnets arranged in or along the flexible elongated member to allow for adjustment of the distance along the flexible elongated member between the housing and one of the magnets of the array that magnetically engages with the first attachment member, the second attachment member being adapted for engaging magnetically with the first attachment member through the auricle of the user with the distance matching the size of the auricle of the user.

An audio output apparatus which comprises two separate attachment members, which are magnetically attracted to each other through the auricle of the user, and where one of the attachment members comprises an array of magnets, is properly secured to the ear of the user even during physical activity such as sports. The apparatus is especially suitable for use in connection with Bluetooth earphones that do not extend into the ear canal. Also, the apparatus is highly flexible in that it may be adjusted to fit a wide range of differently shaped ears comfortably. Further, the apparatus is easy to use and does not take up much space, neither in use nor when not in use.

In a first possible implementation form of the second aspect, the first attachment member comprises a permanent magnet or a magnetic material.

In a second possible implementation form of the second aspect, the housing is shaped to at least partially be received in a cavum of concha of the auricle.

In a third possible implementation form of the second aspect, the housing is an earbud.

In a fourth possible implementation form of the second aspect, the flexible elongated member is a cord, a wire, or a cable.

This object is also achieved according to a third aspect by an audio output apparatus adapted for being releasably attached to an auricle of a user, the apparatus comprising a first attachment member and a second attachment member, the first attachment member and the second attachment member being magnetically attracted to each other, a housing comprising an audio output component and the first attachment member, a flexible elongated member extending from the housing, the first attachment member comprising a permanent magnet, the second attachment member comprising an elongated element of magnetic material extending in or along the flexible elongated member to allow for adjustment of the distance along the flexible elongated member between the housing and a section of the second attachment member that magnetically engages with the first attachment member, the second attachment member being adapted for engaging magnetically with the first attachment member through the auricle of the user with the distance matching the size of the auricle of the user.

An audio output apparatus which comprises two separate attachment members, which are magnetically attracted to each other through the auricle of the user, and where one of the attachment members comprises an elongated element of magnetic material, is properly secured to the ear of the user even during physical activity such as sports. The apparatus is especially suitable for use in connection with Bluetooth earphones that do not extend into the ear canal. Also, the apparatus is highly flexible in that it may be adjusted to fit a wide range of differently shaped ears comfortably. Further, the apparatus is easy to use and does not take up much space, neither in use nor when not in use.

In a first possible implementation form of the third aspect, the housing is shaped to at least partially be received in a cavum of concha of the auricle.

In a second possible implementation form of the third aspect, the housing is an earbud.

In a third possible implementation form of the third aspect, the flexible elongated member is a cord, a wire, or a cable.

This object is also achieved according to a fourth aspect by a headset adapted for being releasably attached to each of the left auricle and right auricle of a user, the apparatus comprising a first housing for engaging the cavum of concha of the left auricle, a second housing for engaging the cavum of concha of the right auricle, the first housing comprising an audio output component and a first permanent magnet, the second housing comprising an audio output component member and a second permanent magnet, a first flexible elongated member extending from the first housing, a second flexible elongated member extending from the second housing, a third permanent magnet in a third housing secured to the first flexible elongated member at a distance from the first housing measured along the first flexible elongated member, a fourth permanent magnet in a fourth housing secured to the second flexible elongated member at a distance from the second housing measured along the second flexible elongated member, the first permanent magnet and the third permanent magnet being arranged in the first housing and the third housing respectively, to allow the first permanent magnet and the third permanent magnet to magnetically engage through the wall of the left auricle of the user, the second permanent magnet and the fourth permanent magnet being arranged in the second housing and the fourth housing respectively, to allow the second permanent magnet and the fourth permanent magnet to magnetically engage through the wall of the right auricle of the user, the first permanent magnet and the second permanent magnet being arranged in the first housing and the second housing respectively, to allow of the first permanent magnet and the second permanent magnet to magnetically engage, and the third permanent magnet and the fourth permanent magnet being arranged in the third housing and the fourth housing respectively, to allow the third permanent magnet and the fourth permanent magnet to magnetically engage.

A headset comprising two audio output apparatuses according to the above, is properly secured to the ears of the user even during physical activity such as sports. Also, the headset is highly flexible in that it may be adjusted to fit a wide range of differently shaped ears comfortably. Further, the headset is easy to use and does not take up much space, neither in use nor when not in use. When not in use, the headset may be either discretely, comfortably, and securely arranged around the neck of the user. Further, the headset may be stored elsewhere with a minimal risk of entanglement when the two audio output apparatuses are interconnected, and of losing one of the audio output apparatus should they not be interconnected.

In a first possible implementation form of the fourth aspect, the first flexible elongated member and the second flexible elongated member are interconnected at the ends which do not extend from the first housing and the second housing, and the third permanent magnet in the third housing is secured to the flexible elongated member at a distance along the flexible elongated member between the first housing and the second housing, and the fourth permanent magnet in a fourth housing is secured to the flexible elongated member at a distance along the flexible elongated member between the second housing and the third housing.

In a second possible implementation form of the fourth aspect, the first housing and the second housing are provided with matching engagement surfaces.

In a third possible implementation form of the fourth aspect, the third housing and the fourth housing are provided with matching engagement surfaces.

In a fourth possible implementation form of the fourth aspect, the first housing and the second housing and/or the third housing and the fourth housing together form a complete shape, such as a sphere, when the matching engagement surfaces are engaged.

In a fifth possible implementation form of the fourth aspect, the housing is shaped to at least partially be received in a cavum of concha of the auricle.

In a sixth possible implementation form of the fourth aspect, the housing is an earbud.

In a seventh possible implementation form of the fourth aspect, the flexible elongated member is a cord, a wire, or a cable.

This object is also achieved according to a fifth aspect by a method of attaching an audio output apparatus according to any one of the above aspects to an auricle of a user, comprising: positioning the housing and the first attachment member of the apparatus at least partially in a cavum of concha of the auricle, arranging the flexible elongated member such that it extends from the housing, over the upper section of the auricle, to the opposite side of the auricle, positioning the second attachment member, connected to the flexible elongated member at the opposite side of the auricle, magnetically connecting the second attachment member through the wall of the auricle, to the first attachment member.

In a first possible implementation form of the fifth aspect, the method further comprises the step of adjusting the distance between the housing and the second attachment member along the flexible elongated member such that the distance matches the size of the auricle of the user.

In a second possible implementation form of the fifth aspect the method further comprises the step of adjusting the position of the second attachment member such that a section of the second attachment member engages magnetically with the first attachment member, at a desired position on the second attachment member.

The foregoing and other objects are achieved by the features of the independent claims. Further implementation forms are apparent from the dependent claims, the detailed description, and the figures.

### BRIEF DESCRIPTION OF THE DRAWINGS

In the following detailed portion of the present disclosure, the invention will be explained in more detail with reference to the example embodiments shown in the drawings, in which:

FIG. 1 is a schematic illustration of an example embodiment of an audio output apparatus provided with an adjustable attachment component.

FIG. 2 is a schematic illustration of an example embodiment of an audio output apparatus provided with a plurality of attachment components.

FIG. 3 is a schematic illustration of an example embodiment of an audio output apparatus provided with an elongate attachment component.

FIG. 4 is a schematic illustration of an embodiment of an adjustable attachment component.

FIG. 5 is a schematic illustration of a further embodiment of an adjustable attachment component.

FIG. 6 is a schematic illustration of an embodiment of an elongate attachment component.

FIG. 7 illustrates an example embodiment of a headset according to the present disclosure.

FIG. 8 is a further illustration of the embodiment in FIG. 7, wherein the attachment components are disconnected from each other.

FIG. 9 illustrated a further illustration of the embodiment in FIG. 7, wherein some of the attachment components are connected to each other.

FIGS. 10 and 11 illustrate yet another embodiment.

### DETAILED DESCRIPTION

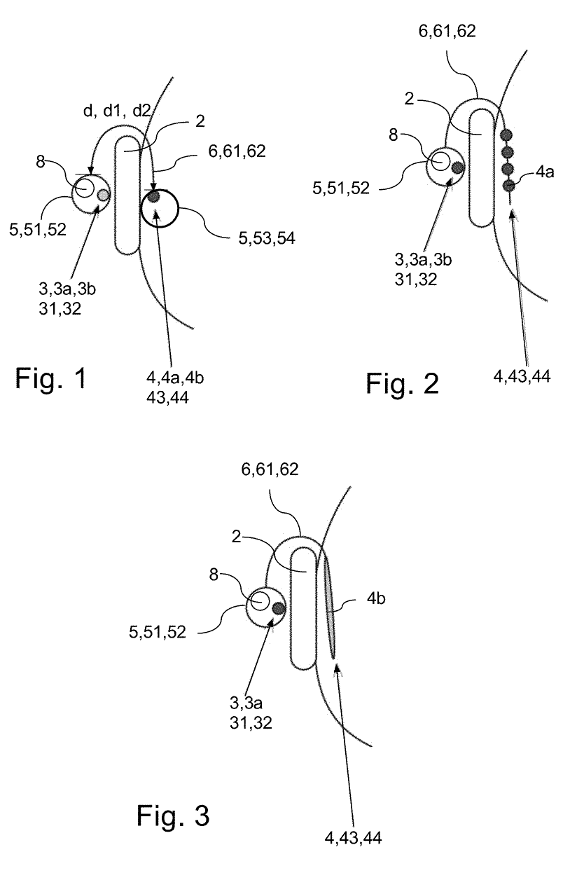

FIGS. 1 to 3 schematically show an audio output apparatus adapted for being releasably attached to an auricle 2 of a user. The apparatus comprises a first attachment member 3 and a second attachment member 4, which are magnetically attracted to each other. The magnetic attraction is strong enough to attach the two attachment members to the auricle by placing them on opposite sides of the wall of the auricle. The first attachment member 3 is arranged within a housing 5 along with an audio output component 8 such as a speaker. The housing can be an earbud, and it can have any shape which is suitable for it to be least partially received in a cavum of concha of the auricle 2, i.e. many shapes are known to provide a suitable fill between the earbud and the ear of the user.

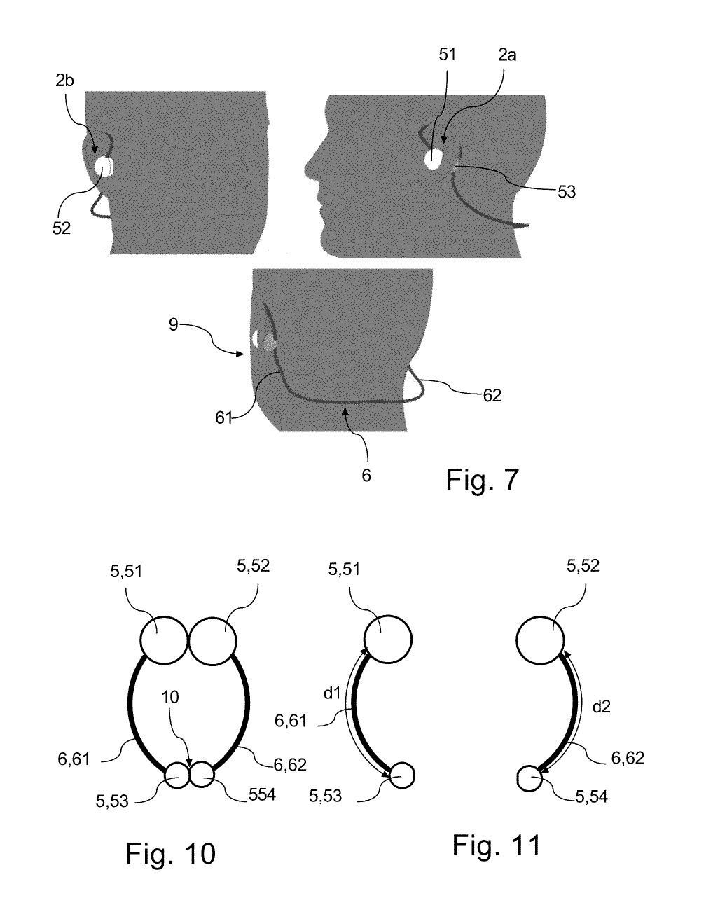

A flexible elongated member 6 extends from the housing 5, the flexible elongated member 6 being e.g. a cord, a wire, or a cable. The second attachment member 4 is arranged at a position along the flexible elongated member 6. In use, as shown in FIG. 7, the housing 5 and the first attachment member 3 are placed in the cavum of concha of the auricle (the front of the ear), the flexible elongated member 6 pulled over the upper portion of the auricle, to the back of the auricle (the back of the ear) where the second attachment member 4 will be placed. The magnetic attraction pulls the two attachment members towards each other, engaging them magnetically, and securing them to the auricle. Further support will be provided by the section of flexible elongated member 6 which rests upon the upper portion of the auricle, or more specifically on a portion of the transition between the ear and head of the user.

In one embodiment, shown in FIG. 1, the second attachment member 4 is adjustably secured to the flexible elongated member 6, i.e. it can be slid along the flexible elongated member 6. This allows manual adjustment of the distance d along the flexible elongated member 6 which extends between the housing 5/first attachment member 3 and the second attachment member 4. By moving the second attachment member 4 along the flexible elongated member 6, the user can adjust the distance between the two attachment members 3,4 to make the audio output apparatus fit the exact size of his or her auricle 2.

The attachment members 3, 4 may comprise either a permanent magnet 3a, 4a or a magnetic material 3b, 4b. In one embodiment, both the first attachment member 3 and the second attachment member 4 comprise a permanent magnet 3a, 4a. In a further embodiment, one of the attachment members 3, 4 comprise a permanent magnet 3a, 4a while the other attachment member 4, 3 comprise a magnetic material 3b, 4b.

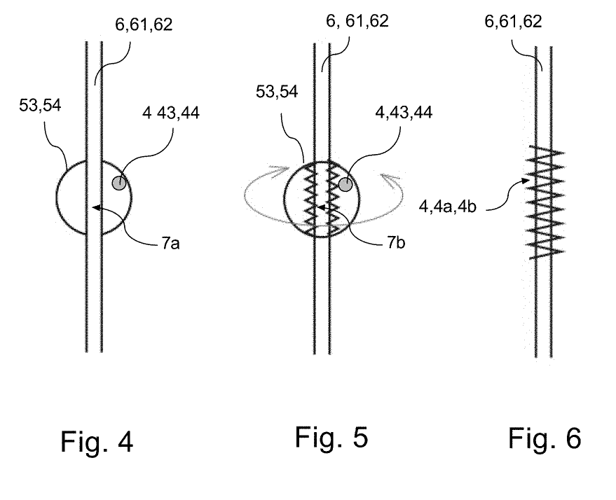

The moveable second attachment member 4 comprises, in the embodiment shown in FIG. 4, a channel 7a which has a surface with sufficient friction to secure the second attachment member 4 on the flexible elongated member 6, e.g. due to a slight press fit. The second attachment member is maintained on the flexible elongated member 6 while still allowing it to be moved along the flexible elongated member 6 by the user.

In another embodiment, shown in FIG. 5, the second attachment member comprises a threaded channel 7b which interacts with a correspondingly threaded section of the flexible elongated member 6 or interacts with the flexible elongated member 6 through the latter's resiliency so that the inner thread of the channel 7b deforms flexible elongated member 6 in an way resembling an external thread.

The first and second attachment members 3,4 may have any suitable shape such as circular, semi-circular, or a hollow or a solid tube.

In yet another embodiment, shown in FIG. 2, the second attachment member 4 comprises an array of permanent magnets 4a arranged in or along the flexible elongated member 6. This allows manual adjustment of the distance d along the flexible elongated member 6 which extends between the housing 5/first attachment member 3 and the second attachment member 4. By moving the array of magnets 4a and the entire flexible elongated member 6, the user can adjust the distance d between the first attachment member 3 and any one magnet 4a, i.e. section of the second attachment member 4, such that the audio output apparatus fits the exact size of his or her auricle 2.

The attachment member 3 comprises either a permanent magnet 3a or a magnetic material 3b.

In a further embodiment, shown in FIG. 3, the first attachment member 3 comprises a permanent magnet 3a and the second attachment member 4 comprises an elongated element of magnetic material 4b. The elongated element of magnetic material 4b extends either in or along the flexible elongated member 6. This allows manual adjustment of the distance d along the flexible elongated member 6 which extends between the housing 5/first attachment member 3 and the elongated element 4b. By moving the elongated element 4b and the entire flexible elongated member 6, the user can adjust the distance d between the first attachment member 3 and any suitable section of the elongated element 4b such that the audio output apparatus fits the exact size of his or her auricle 2.

The elongated element of magnetic material 4b may be shaped as a hollow or a solid tube either threaded onto the flexible elongated member 6, included in the flexible elongated member 6. Further, the entire flexible elongated member 6 could comprise of magnetic material 4b, such that any position on the flexible elongated member 6 itself may be connected magnetically with the permanent magnet 4a. FIG. 6 shows an embodiment in which the elongated element has the shape of a spiral which is wound around a portion of the flexible elongated member 6. The flexible elongated member 6 has an outer diameter which is somewhat larger than the inner diameter of the spiral, such that the spiral is secured to the flexible elongated member 6 by an interference fit.

The audio output apparatus is attached to the auricle 2 of the user by means of the following steps. The housing 5 and the first attachment member 3 are positioned at least partially in the cavum of concha of the auricle 2. The flexible elongated member 6 is arranged such that it extends from the housing 5, upwards over the upper section of the auricle 2, back to the opposite side of the auricle 2. At this point, the first attachment member 3 is positioned at the front (lateral side) of the auricle and the second attachment member 4 is positioned at the back (distal side) of the auricle, i.e. the opposite side of the auricle 2. This allows the second attachment member 4 to interconnect magnetically, through the wall of the auricle 2, to the first attachment member 3.

In one embodiment, attaching the audio output apparatus to the auricle 2 further comprises the step of adjusting the distance d between the housing 5 and the second attachment member 4 as measured along the flexible elongated member 6 such that the distance d matches the size of the auricle 2 of the user.

In a further embodiment, attaching the audio output apparatus to the auricle 2 comprises the step of adjusting the position of the second attachment member 4 such that a section of the second attachment member 4 engages magnetically with the first attachment member 3, at a desired position on the second attachment member 4.

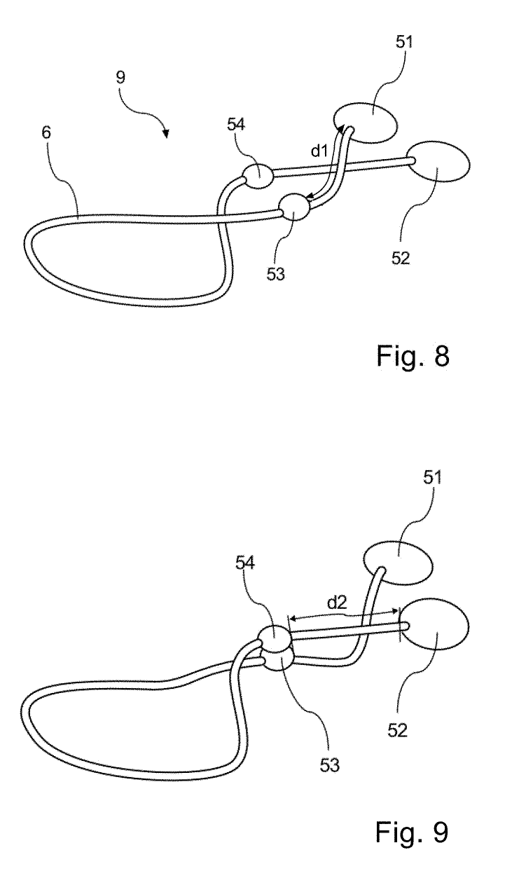

FIGS. 7 to 9 show a headset comprising two audio output apparatuses, attached to the left auricle 2a and the right auricle 2b, respectively.

The headset comprises a first housing 51 for engaging the cavum of concha of the left auricle 2a and a second housing 52 for engaging the cavum of concha of the right auricle 2b. The first housing 51 comprises an audio output component 8 and a first permanent magnet 31, and the second housing 52 comprises an audio output component 8 and a second permanent magnet 32. A first flexible elongated member 61 extends from the first housing 51, and a second flexible elongated member 62 extends from the second housing 52. A third permanent magnet 43, in a third housing 53, is secured to the first flexible elongated member 61 at a distance d1 from the first housing 51 measured along the first flexible elongated member 61. A fourth permanent magnet 44, in a fourth housing 54, is secured to the second flexible elongated member 62 at a distance d2 from the second housing 52 measured along the second flexible elongated member 62.

The first permanent magnet 31 and the third permanent magnet 43 are arranged in the first housing 51 and the third housing 53, respectively, such that the first permanent magnet 31 and the third permanent magnet 43 are allowed to engage magnetically through the wall of the left auricle 2a of the user. Correspondingly, the second permanent magnet 32 and the fourth permanent magnet 44 are arranged in the second housing 52 and the fourth housing 54, respectively, such that the second permanent magnet 32 and the fourth permanent magnet 44 are allowed to engage magnetically through the wall of the right auricle 2b of the user.

Further, the first permanent magnet 31 and the second permanent magnet 32 are arranged in the first housing 51 and the second housing 52 respectively, such that the first permanent magnet 31 and the second permanent magnet 32 are allowed to engage magnetically, e.g. when not being used. This is illustrated in FIG. 10.

Also, the third permanent magnet 43 and the fourth permanent magnet 44 are arranged in the third housing 53 and the fourth housing 54, respectively, such that the third permanent magnet 43 and the fourth permanent magnet 44 are allowed to engage magnetically. This is illustrated in FIGS. 9 and 10.

The permanent magnets 31, 32, 43, 44 are all arranged within their respective housing such that they are allowed to engage magnetically with at least two of the other permanent magnets.

The magnets 31, 32, 43, 44 may have north and south poles, in which case the magnets must be arranged within their respective housing such that they allow the opposite poles of two magnets to engage.

I.e., the first permanent magnet 31 and the third permanent magnet 43 are arranged in the first housing 51 and the third housing 53 respectively, to allow opposite poles of the first permanent magnet 31 and the third permanent magnet 43 to magnetically engage through the wall of the left auricle 2a of the user. The second permanent magnet 32 and the fourth permanent magnet 44 are arranged in the second housing 52 and the fourth housing 54 respectively, to allow opposite poles of the second permanent magnet 32 and the fourth permanent magnet 44 to magnetically engage through the wall of the right auricle 2b of the user. The first permanent magnet 31 and the second permanent magnet 32 are arranged in the first housing 51 and the second housing 52 respectively, to allow opposite poles of the first permanent magnet 31 and the second permanent magnet 32 to magnetically engage. The third permanent magnet 43 and the fourth permanent magnet 44 are arranged in the third housing 53 and the fourth housing 54 respectively, to allow opposite poles of the third permanent magnet 43 and the fourth permanent magnet 44 to magnetically engage.

The magnet may also be a layered magnet, in which case one does not need to consider direction of the poles of the magnets, but instead can position the magnets within respective housing simply such that a suitably strong magnetic engagement is achieved.

In an embodiment, the first flexible elongated member 61 and the second flexible elongated member 62 are interconnected at the ends which do not extend from the first housing 51 and the second housing 52. I.e., the two flexible elongated members 61, 62 form one single flexible elongated member 6 which extends between the first housing 51 and the second housing 52, as show in FIGS. 7 to 9. The third permanent magnet 43 in the third housing 53 is secured to the flexible elongated member 6 at a distance d1, from the first housing 51, along the flexible elongated member 6 between the first housing 51 and the third housing 53. The fourth permanent magnet 44 in a fourth housing 54 is secured to the flexible elongated member 6 at a distance d2, from the second housing 52, along the flexible elongated member 6 between the second housing 52 and the fourth housing 54.

In one embodiment, first housing 51 and the second housing 52 are provided with matching engagement surfaces 10. In a further embodiment, the third housing 53 and the fourth housing 54 are provided with matching engagement surfaces 10. The first housing 51 and the second housing 52 and/or the third housing 53 and the fourth housing 54 may together form a complete shape when the matching engagement surfaces 10 are engaged.

FIGS. 10 and 11 illustrate an embodiment in which the headset comprises two separable audio output apparatuses not physically interconnected by the flexible elongated member 6, e.g. a cord or cable. In FIG. 10 the two separable audio output apparatuses are magnetically connected and in FIG. 11 the two separable audio output apparatuses are separated. The first separable audio output apparatus comprises the first housing 51 and the third housing 53, connected to one another by the flexible elongated member 61. The second inseparable audio output apparatus comprises the second housing 52 and the fourth housing 54, connected to one another by the flexible elongated member 62. In the state in which the first and second separable audio output apparatuses are magnetically connected, as shown in FIG. 10, the first housing 51 and the second housing 52 are magnetically connected to one another and the third housing 53 and the fourth housing 54 are also magnetically connected to one another, thereby providing an arrangement in which the headset only has one single part for storage and transportation, i.e. when it is not in use. This simple and compact arrangement shown in FIG. 10 allows for easy transport and storage. When a user wishes to take the headset into use, he/she can simply pull the first part of the headset and the second part of the headset away from one another as shown in FIG. 11 by breaking the magnetic connection of the respective parts and thereafter place the respective parts of the headset on his/her left and right ears/auricles.

As previously mentioned, the first housing 51 and the third housing 53, and also the second housing 52 and the fourth housing 54, may be magnetically connected to each other. Further, the first housing 51 and the fourth housing 54, as well as the second housing 52 and the third housing 53, may be magnetically connected to one another in a corresponding way.

In any of the embodiments the headset could be an earphone or e.g. a hearing aid.

The various aspects and implementations has been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

The reference signs used in the claims shall not be construed as limiting the scope.

1. An audio output apparatus (1) adapted for being releasably attached to an auricle (2) of a user,
said apparatus comprising:
a first attachment member (3) and a second attachment member (4), said first attachment member (3) and said second attachment member (4) being magnetically attracted to each other,
a housing (5) comprising an audio output component (8) and said first attachment member (3),
a flexible elongated member (6) extending from said housing (5),
said second attachment member (4) being secured to said flexible elongated member (6) at an adjustable position along said flexible elongated member (6) to allow for manual adjustment of a distance (d) along the flexible elongated member (6) between the housing (5) and the second attachment member (4), said second attachment member (4) being adapted for engaging magnetically with said first attachment member (3) through the auricle (2) of the user with said distance (d) matching the size of the auricle (2) of the user.

2. An audio output apparatus (1) according to claim 1, wherein one of said first attachment member (3) and said second attachment member (4) comprises a permanent magnet (3a, 4a), and one of said second attachment member (4) and said first attachment member (3) comprises a magnetic material (3b, 4b).

3. An audio output apparatus (1) according to claim 1, wherein said first attachment member (3) and said second attachment member (4) both comprise a permanent magnet (3a, 4a).

4. An audio output apparatus (1) according to claim 1, wherein said first attachment member (3) comprises a permanent magnet (3a) and said second attachment member (4) is a wire of magnetic material arranged within or along said flexible elongated member (6).

5. An audio output apparatus (1) according to claim 1, wherein said second attachment member (4) comprises a channel (7a) through which said flexible elongated member (6) extends, said second attachment member being maintained on said flexible elongated member (6) by means of friction.

6. An audio output apparatus (1) according to claim 1, wherein said second attachment member comprises a threaded channel (7b) through which a correspondingly threaded section of said flexible elongated member (6) extends.

7. An audio output apparatus (1) according to claim 1, wherein said housing (5) is shaped to at least partially be received in a cavum of concha of said auricle (2).

8. An audio output apparatus (1) according to claim 7, wherein said housing (5) is an earbud.

9. An audio output apparatus (1) according to claim 1, wherein said flexible elongated member (6) is a cord, a wire, or a cable.

10. An audio output apparatus (1) adapted for being releasably attached to an auricle (2) of a user,
said apparatus comprising:
a first attachment member (3) and a second attachment member (4), said first attachment member (3) and said second attachment member (4) being magnetically attracted to each other,
a housing (5) comprising an audio output component (8) and said first attachment member (3),
a flexible elongated member (6) extending from said housing (5),
said second attachment member (4) comprising an array of magnets or elements of magnetic material (4a) arranged in or along said flexible elongated member (6) to allow for adjustment of the distance (d) along the flexible elongated member (6) between the housing (5) and one of the magnets (4a) of said array that magnetically engages with said first attachment member (3), said second attachment member (4) being adapted for engaging magnetically with said first attachment member (3) through the auricle (2) of the user with said distance (d) matching the size of the auricle (2) of the user.

11. An audio output apparatus (1) according to claim 10, wherein said first attachment member (3) comprises a permanent magnet (3a) or a magnetic material (3b).

12. An audio output apparatus (1) according to claim 10, wherein said housing (5) is shaped to at least partially be received in a cavum of concha of said auricle (2).

13. An audio output apparatus (1) according to claim 12, wherein said housing (5) is an earbud.

14. An audio output apparatus (1) according to claim 10, wherein said flexible elongated member (6) is a cord, a wire, or a cable.

15. An audio output apparatus (1) adapted for being releasably attached to an auricle (2) of a user,
said apparatus comprising:
a first attachment member (3) and a second attachment member (4), said first attachment member (3) and said second attachment member (4) being magnetically attracted to each other,
a housing (5) comprising an audio output component (8) and said first attachment member (3),
a flexible elongated member (6) extending from said housing (5),
said first attachment member (3) comprising a permanent magnet (3a),
said second attachment member (4) comprising an elongated element of magnetic material (4b) extending in or along said flexible elongated member (6) to allow for adjustment of the distance (d) along the flexible elongated member (6) between the housing (5) and a section of the second attachment member (4) that magnetically engages with said first attachment member (3), said second attachment member (4) being adapted for engaging magnetically with said first attachment member (3) through the auricle (2) of the user with said distance (d) matching the size of the auricle (2) of the user.

16. An audio output apparatus (1) according to claim 15, wherein said housing (5) is shaped to at least partially be received in a cavum of concha of said auricle (2).

17. An audio output apparatus (1) according to claim 16, wherein said housing (5) is an earbud.

18. An audio output apparatus (1) according to claim 15, wherein said flexible elongated member (6) is a cord, a wire, or a cable.

19. A headset (9) adapted for being releasably attached to each of the left auricle (2a) and right auricle (2b) of a user,
said headset comprising:
a first housing (51) for engaging the cavum of concha of said left auricle (2a),
a second housing (52) for engaging the cavum of concha of said right auricle (2b),
said first housing (51) comprising an audio output component (8) and a first permanent magnet (31),
said second housing (52) comprising an audio output component (8) member and a second permanent magnet (32),
a first flexible elongated member (61) extending from said first housing (51),
a second flexible elongated member (62) extending from said second housing (52),
a third permanent magnet (43) in a third housing (53) secured to said first flexible elongated member (61) at a distance (d1) from said first housing (51) measured along the first flexible elongated member (61),
a fourth permanent magnet (44) in a fourth housing (54) secured to said second flexible elongated member (62) at a distance (d2) from said second housing (52) measured along the second flexible elongated member (62),
said first permanent magnet (31) and said third permanent magnet (43) being arranged in the first housing (51) and the third housing (53) respectively, to allow the first permanent magnet (31) and the third permanent magnet (43) to magnetically engage through the wall of the left auricle (2a) of the user,
said second permanent magnet (32) and said fourth permanent magnet (44) being arranged in the second housing (52) and the fourth housing (54) respectively, to allow the second permanent magnet (32) and the fourth permanent magnet (44) to magnetically engage through the wall of the right auricle (2b) of the user,
said first permanent magnet (31) and said second permanent magnet (32) being arranged in the first housing (51) and the second housing (52) respectively, to allow the first permanent magnet (31) and the second permanent magnet (32) to magnetically engage, and
said third permanent magnet (43) and said fourth permanent magnet (44) being arranged in the third housing (53) and the fourth housing (54) respectively, to allow the third permanent magnet (43) and the fourth permanent magnet (44) to magnetically engage.

20. A headset (9) according to claim 19, wherein said first flexible elongated member (61) and said second flexible elongated member (62) are interconnected at the ends which do not extend from said first housing (51) and said second housing (52), and wherein
said third permanent magnet (43) in said third housing (53) is secured to said flexible elongated member (6) at a distance (d1) along the flexible elongated member (6) between the first housing (51) and the third housing (53), and
said fourth permanent magnet (44) in a fourth housing (54) is secured to said flexible elongated member (6) at a distance (d2) along the flexible elongated member (6) between the second housing (52) and the fourth housing (54).

21. A headset (9) according to claim 19, wherein said first housing (51) and said second housing (52) are provided with matching engagement surfaces (10).

22. A headset (9) according to claim 19, wherein said third housing (53) and said fourth housing (54) are provided with matching engagement surfaces (10).

23. A headset (9) according to claim 21, wherein said first housing (51) and said second housing (52) and/or said third housing (53) and said fourth housing (54) together form a complete shape, such as a sphere, when said matching engagement surfaces (10) are engaged.

24. A headset (9) according to claim 20, wherein said housing (51, 52) is shaped to at least partially be received in a cavum of concha of said auricle (2).

25. A headset (9) according to claim 24, wherein said housing (51, 52) is an earbud.

26. A headset (9) according to claim 20, wherein said flexible elongated member (6, 61, 62) is a cord, a wire, or a cable.

27. A method of attaching an audio output apparatus (1) according to claim 1 to an auricle (2) of a user, comprising the steps of:
positioning the housing (5) and the first attachment member (3) of the apparatus at least partially in a cavum of concha of said auricle (2),
arranging the flexible elongated member (6) such that it extends from said housing (5), over the upper section of said auricle (2), to the opposite side of said auricle (2), positioning the second attachment member (4), connected to said flexible elongated member (6) at the opposite side of said auricle (2),
magnetically connecting said second attachment member (4) through the wall of said auricle (2), to said first attachment member (3).

28. A method according to claim 27, further comprising the step of adjusting the distance (d) between said housing (5) and said second attachment member (4) along said flexible elongated member (6) such that said distance (d) matches the size of the auricle (2) of the user.

29. A method according to claim 27, further comprising the step of adjusting the position of said second attachment member (4) such that a section of said second attachment member (4) engages magnetically with said first attachment member (3), at a desired position on said second attachment member (4).
